(19) United States
(12) Patent Application Publication
(10) Pub. No.: US 2009/0169965 A1
(43) Pub. Date: Jul. 2, 2009

(54) GAS-LIQUID SEPARATING APPARATUS AND LIQUID SUPPLY TYPE FUEL CELL

(75) Inventors: Yoshinori Watanabe, Tokyo (JP); Takashi Manako, Tokyo (JP); Hiroshi Kajitani, Tokyo (JP); Hideyuki Satou, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/094,706

(22) PCT Filed: Nov. 15, 2006
(86) PCT No.: PCT/JP2006/322735

§ 371 Date: May 22, 2008

(30) Foreign Application Priority Data
Nov. 22, 2005 (JP) 2005-336816

(51) Int. Cl. H01M 2/14

(52) U.S. Cl. 429/34

(57) ABSTRACT

A gas-liquid separating apparatus includes a container 41 and gas-liquid separating membranes 43, 44. The container 41 has a substantially rectangular solid shape and has an inlet E1 and an outlet E2 for liquid. The gas-liquid separating membranes are provided for two side surfaces 41-1, 41-2 opposing to each other in said container. First sides included in the two side surfaces 41-1, 41-2 are longer than second sides, which are adjacent to the first sides, in a section of the container perpendicular to the two side surfaces 41-1, 41-2.

### TECHNICAL FIELD

The present invention relates to a gas-liquid separating apparatus and a liquid supply type fuel cell using the same.

### BACKGROUND ART

A small fuel cell is known like a direct methanol fuel cell (hereinafter, to be referred to as “DMFC”), which uses a methanol-water solution as liquid fuel. The small fuel cell could be installed in a small electronic apparatus such as a handheld terminal and a portable audio-visual equipment. Here, the handheld terminal is exemplified by a notebook personal computer, a PDA (Personal Digital Assistant), and a cellular phone. The portable audio-visual equipment is exemplified by a portable radio/television, a portable video player, and a portable music player. In case of the small fuel cell, a gas is generated with power generation and the gas needs to be discharged outside a system. For this reason, a gas-liquid separating membrane has been attached to the top surface of a fuel tank which mixes new liquid fuel and residual liquid fuel circulated from the fuel cell, for example. As a result, the gas contained in the circulated residual liquid fuel can be discharged outside a system through the gas-liquid separating membrane.

A small electronic apparatus into which the small fuel cell is installed, would be used in various attitudes, and the gas generated in power generation and the liquid fuel need to be separated without depending on the attitudes.

In case of attaching the gas-liquid separating membrane to the top surface of the fuel tank, discharge of the gas would be difficult depending on attitudes, which is not preferable. A apparatus that can separate the gas generated in the power generation and the liquid fuel without depending on the attitude of the small electronic apparatus (hereinafter, to be referred to as a “gas-liquid separating apparatus”) is desired, especially a small and thin gas-liquid separating apparatus that can be easily installed into the small electronic apparatus.

As a related art, a technique of a gas-liquid separation tank for a fuel cell is disclosed in Japanese Patent Application Publication (JP-P2004-206917A). The gas-liquid separation tank includes a fuel liquid reservoir, a gas-liquid separating membrane, a fuel liquid supply tube, a liquid fuel injection port, a liquid inlet, and a gas inlet. The gas-liquid separating membrane is a lamination of a ventilation film and nonwoven cloth and discharges a gas from the fuel liquid reservoir outside it. The fuel liquid supply tube is fixed such that an opening section at one end is positioned at the gravity center of the fuel liquid reservoir, and supplies fuel liquid to a fuel cell. The liquid fuel is injected into the fuel liquid reservoir from the liquid fuel injection port. The liquid inlet introduces water generated in the fuel cell into the fuel liquid reservoir. The gas inlet introduces the gas generated in the fuel cell into the fuel liquid reservoir.

This technique intends to make it possible to supply liquid fuel to the fuel cell without depending on the attitude by keeping an opening section of the fuel liquid supply tube immerged in the fuel liquid without depending on attitudes. However, there is no mention and suggestion of a method for gas-liquid separation in the fuel liquid reservoir, and it is not clear whether or not the gas generated in the fuel cell and the fuel liquid can properly be separated without depending on the attitude.

### DISCLOSURE OF INVENTION

An object of the present invention is to provide a gas-liquid separating apparatus that can separate gas generated in power generation from liquid fuel without depending on any attitude of a small electronic apparatus, and a liquid supply type fuel cell.

Another object of the present invention is to provide a small and thin gas-liquid separating apparatus that can be easily installed in a small electronic apparatus, and a liquid supply type fuel cell.

These objects of the present invention and other objects and benefits of the present invention can easily be understood from the description below and the attached drawings.

In order to attain a subject matter, a gas-liquid separating apparatus of the present invention has a container and gas-liquid separating membranes. The container has a substantially rectangular solid shape and having an inlet and an outlet for liquid. The gas-liquid separating membranes are provided to two side surfaces opposing to each other in the substantially rectangular solid shape of the container. In a section of the container perpendicular to the two side surfaces opposing to each other, first sides included in the two side surfaces opposing to each other are longer than second sides, which are adjacent to the first sides.

Here, the substantially rectangular solid shape means that a shape having roundness at a corner, roundness of a side surface, misalignment from a parallel, and so forth is allowable in the scope of technical ideas of the present invention. It is also meant that a case of an imperfect rectangular solid due to a manufacturing error and so forth is applicable.

Since the gas-liquid separating membranes are provided to the side surfaces that include the first sides longer than the second sides in the present invention, influence of attitude of a small electronic apparatus on whether gas in liquid reaches the gas-liquid separating membranes can be suppressed smaller.

In the above gas-liquid separating apparatus, the respective areas of the two side surfaces opposing to each other are larger than the areas of the other side surfaces of the container.

In the present invention, gas-liquid separation can be performed more effectively since the gas-liquid separating membranes are provided to the largest side surfaces. Consequently, the influence of the attitude is less and the container can be miniaturized.

In the above gas-liquid separating apparatus, a length X of the first sides and a length Y of the second sides are 5Y being equal to or smaller than X.

In the present invention, the influence of attitude is much less by setting the first sides in such a range.

In the above gas-liquid separating apparatus, the container has therein, a partition member provided in a position to block the liquid flow. The gas-liquid separating membranes are provided to two side surfaces opposing to each other on the side of the inlet in the vicinity of the partition member.

In the present invention, a portion where liquid is likely to stay is formed by the partition member and the gas-liquid separating membranes are provided in the portion, to make it possible to improve a probability that gas comes into contact with the gas-liquid separating membranes due to the stay and further improve the probability since growth of bubbles of gas is accelerated. As a result, the influence of the attitude can be less and the container can be miniaturized.

In the above gas-liquid separating apparatus, gas-liquid separating membranes are further provided to two side surfaces opposing to each other on the side of the inlet in the vicinity of the outlet.

In the present invention, it is possible to further improve a probability that the gas comes into contact with the gas-liquid separating membranes by further providing the gas-liquid separating membranes in the vicinity of the outlet, where the liquid is likely to stay.

In the above gas-liquid separating apparatus, the partition member is provided to block the liquid flow in a portion in a direction of the liquid flow at the inlet at least. The container has a flow passage, where liquid whose flow direction has been changed flows inside or around the partition member.

In the present invention, the partition member can definitely change the flow direction of liquid and make a place where liquid is likely to stay.

In the above gas-liquid separating apparatus, the partition member is provided to move in response to the force of the flow of liquid.

In the present invention, resistance to liquid is within a given range since the partition member waves in the liquid flow.

In the container of the above gas-liquid separating apparatus, a sectional area of a flow passage for liquid includes a first section larger than a sectional area of the inlet and a second section smaller than the sectional area of the first section in a route from the inlet to the outlet. The gas-liquid separating membranes are provided to two side surfaces opposing to each other on the side of the inlet in the first section.

In the present invention, a portion where liquid is likely to stay is formed by the second section and a gas-liquid separating membrane is provided for the first position before the portion, making it possible to improve a probability that gas comes into contact with the gas-liquid separating membrane due to the stay and further improve the probability since growth of bubbles of gas is accelerated. As a result, the influence of the attitude is less and the container can be miniaturized.

In order to attain a subject matter, a gas-liquid separating apparatus of the present invention has a container and gas-liquid separating membranes. The container has an inlet and an outlet for liquid. The gas-liquid separating membranes are provided to two side surfaces of the container opposing to each other at least. The container has therein, a partition member provided in a position to block the liquid flow. The gas-liquid separating membranes are provided to the two side surfaces opposing to each other on the side of the inlet in the vicinity of the partition member.

In the present invention, a portion where liquid is likely to stay is formed by the partition member and the gas-liquid separating membranes are provided in the portion, making it possible to improve a probability that gas comes into contact with the gas-liquid separating membranes due to the stay and further improve the probability since growth of bubbles of gas is accelerated. As a result, the influence of positions can be less and the container can be miniaturized.

In the above gas-liquid separating apparatus, gas-liquid separating membranes are further provided to two side surfaces opposing to each other on the side of the inlet in the vicinity of the outlet.

In the present invention, it is possible to further improve the probability that the gas comes into contact with the gas-liquid separating membranes by further providing the gas-liquid separating membranes in the vicinity of the outlet, where liquid is likely to stay.

In the above gas-liquid separating apparatus, the partition member is provided to block the liquid flow in a position in a direction of the liquid flow at the inlet at least. The container has a flow passage, where liquid whose flow direction was changed flows inside or around the partition member.

In the present invention, the partition member can definitely change the flow direction of liquid and make a place where liquid is likely to stay.

In the above gas-liquid separating apparatus, the partition member is provided to move in response to the force of the flow of liquid.

In the present invention, resistance to liquid can be within a given range since the partition member waves in the flow of fluid.

In order to solve the above problems, a liquid supply fuel cell of the present invention has a fuel cell main body, a fuel supply section, a mixed fuel supply section, and a gas-liquid separating apparatus.

The fuel supply section stores liquid fuel. The mixed fuel supply section stores mixed fuel that is a mixture of liquid fuel and the circulating fuel discharged from the fuel cell main body and supplies the mixed fuel to the fuel cell main body. The gas-liquid separating apparatus is mentioned in any one of the above sections concerning removal of gas contained in the circulating fuel.

### BRIEF DESCRIPTION OF DRAWINGS

FIG. 1 is a block diagram showing a configuration of a polymer electrolyte fuel cell according to the present invention;

FIG. 2A is a diagram (3-view diagram) showing the configuration of a gas-liquid separating apparatus according to a first exemplary embodiment of the present invention;

FIG. 2B is a diagram (cross-section diagram) showing the configuration of the gas-liquid separating apparatus according to the first exemplary embodiment of the present invention;

FIG. 3 is a schematic diagram showing the inside of the gas-liquid separating apparatus;

FIG. 4A is a conceptual diagram showing movement of gas in the gas-liquid separating apparatus;

FIG. 4B is a conceptual diagram showing another movement of gas in the gas-liquid separating apparatus;

FIG. 5A is a diagram (3-view diagram) showing the configuration of the gas-liquid separating apparatus according to a second exemplary embodiment of the present invention;

FIG. 5B is a diagram (cross-section diagram) showing the configuration of the gas-liquid separating apparatus according to the second exemplary embodiment of the present invention;

FIG. 6 is a schematic diagram showing the inside of the gas-liquid separating apparatus;

FIG. 7A is a schematic diagram showing a shape of a partition member;

FIG. 7B is a schematic diagram showing another shape of the partition member;

FIG. 7C is a schematic diagram showing still another shape of the partition member;

FIG. 8A is a diagram (3-view diagram) showing the configuration of the gas-liquid separating apparatus according to a modification example of the second exemplary embodiment of the present invention;

FIG. 8B is a diagram (cross-section diagram) showing the configuration of the gas-liquid separating apparatus according to the modification example of the second exemplary embodiment of the present invention;

FIG. 9 is a diagram showing the configuration of the gas-liquid separating apparatus according to another modification example of the second exemplary embodiment of the present invention; and

FIG. 10 is a diagram showing the configuration of the gas-liquid separating apparatus according to another modification example of the second exemplary embodiment of the present invention.

### BEST MODE FOR CARRYING OUT THE INVENTION

Hereinafter, a gas-liquid separating apparatus and a liquid supply type fuel cell according to the present invention will be described in detail with reference to the attached drawings. Here, the present invention will be described taking a polymer electrolyte fuel cell as an example of the liquid (fuel) supply type fuel cell.

### First Exemplary Embodiment

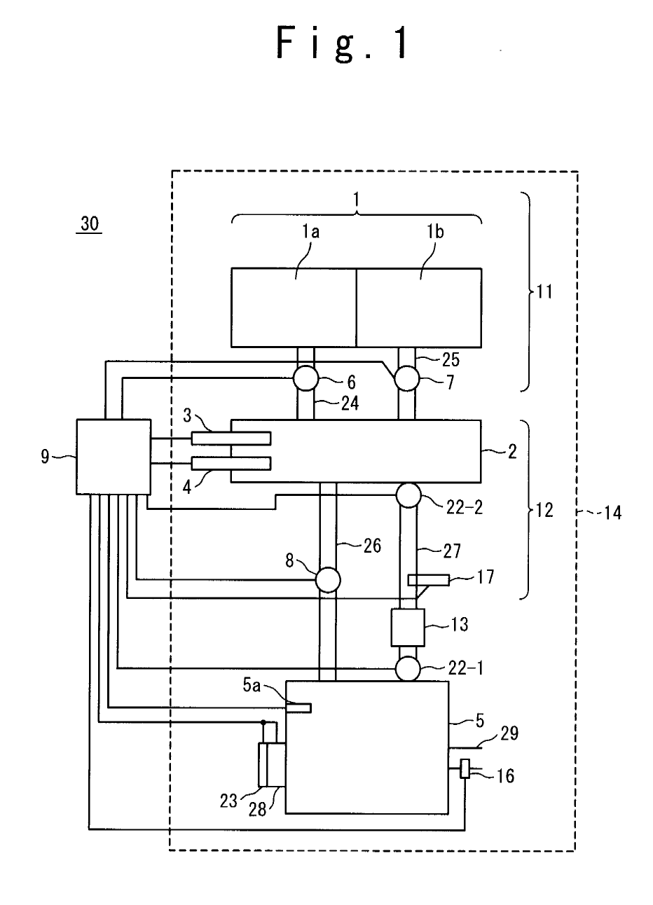

The configuration of the polymer electrolyte fuel cell using the gas-liquid separating apparatus according to a first exemplary embodiment of the present invention will be described. FIG. 1 is a block diagram showing the configuration of the polymer electrolyte fuel cell according to the first exemplary embodiment of the present invention. The polymer electrolyte fuel cell 30 has a fuel cell section 14 and a microcomputer 9.

The fuel cell section 14 generates electric power by using liquid fuel and oxidizer. The fuel cell section 14 has a fuel supply section 11, a mixed fuel supply section 12, a fuel cell stack 5, a gas-liquid separating apparatus 13, a liquid sensor 3, a first temperature sensor 4, a second temperature sensor 16, a third temperature sensor 17, and a voltage probe 5a.

The fuel supply section 11 stores a plurality of types of liquid fuel different in concentration. At least one of the plurality of types of liquid fuel is supplied to the mixed fuel supply section 12 based on the control of a microcomputer 9. The fuel supply section 11 includes a fuel cartridge 1, pumps 6 and 7, and flow passages 24 and 25.

The fuel cartridge 1 includes a plurality of fuel chambers 1a and 1b provided for the respective types of liquid fuel. Here, shown is an example of reserving two types of liquid fuel different in concentration. The fuel chamber 1a reserves a high concentration of liquid fuel, and the fuel chamber 1b reserves a low concentration of liquid fuel. The flow passage 24 connects the fuel chamber 1a and a mixed fuel tank 2 (to be mentioned later) of the mixed fuel supply section 12. The pump 6 sends the high concentration of liquid fuel in the fuel chamber 1a to the mixed fuel tank 2 through the flow passage 24 in the ON sate, and closes the flow passage 24 in the OFF state, under the control of the microcomputer 9. The flow passage 25 connects the fuel chamber 1b and the mixed fuel tank 2. The pump 7 sends the low concentration of liquid fuel in the fuel chamber 1b to the mixed fuel tank 2 through the flow passage 25 in the ON state and closes the flow passage 25 in the OFF state, under the control of the microcomputer 9. The pumps 6 and 7 operate independently of each other.

Here, the liquid fuel is exemplified by organic water solution such as methanol, ethanol, IPA (isopropyl alcohol) and dimethyl ether, or a combination thereof. In case of the low concentration of liquid fuel, however, water with an organic concentration being 0% may be included.

The mixed fuel supply section 12 stores the mixed fuel, which is a mixture of the liquid fuel supplied from the fuel cartridge 1 and circulation fuel sent out from the fuel cell stack 5. Under the control of the microcomputer 9, the mixed fuel is supplied to the fuel cell stack 5. The mixed fuel supply section 12 includes the mixed fuel tank 2, a pump 8, a valve 22-2, and flow passages 26 and 27.

The mixed fuel tank 2 stores the mixed fuel, which is a mixture of the high concentration of liquid fuel supplied through the flow passage 24, the low concentration of liquid fuel supplied through the flow passage 25, and the circulation fuel supplied through the flow passage 27 (to be mentioned later). The flow passage 26 connects the mixed fuel tank 2 and the fuel cell stack 5. Under the control of the microcomputer 9, the pump 8 sends the mixed fuel in the mixed fuel tank 2 to the fuel cell stack 5 in the ON state, and closes the flow passage 26 in the OFF state. The flow passage 27 connects the mixed fuel tank 2 and the fuel cell stack 5. The mixed fuel that has been supplied to the fuel cell stack 5 through the flow passage 26 is partly consumed in the fuel cell stack 5 and is sent as the circulation fuel to the flow passage 27 together with generated water and carbon dioxide. The valve 22-2 opens and closes an exit of the flow passage 27 on the side of the mixed fuel tank 2.

The fuel cell stack 5 includes a plurality of MEAs (Membrane Electrode Assembly), and generates electric power by using the mixed fuel supplied through the flow passage 26 and air as oxidizer. The fuel cell stack 5 includes a valve 22-1, a shutter 23, an oxidizer supply mechanism 28, and an oxidizer discharge outlet 29. The valve 22-1 opens and closes an entrance of the flow passage 27 on the side of the fuel cell stack 5. The oxidizer supply mechanism 28 is exemplified by a fan, and supplies air to an air electrode of the fuel cell stack 5. The shutter 23 opens and closes a feed opening for air to the oxidizer supply mechanism 28. The oxidizer discharge outlet 29 is a discharge outlet for air that has passed through the air electrode.

The gas-liquid separating apparatus 13 (13a in the first exemplary embodiment) is provided in a middle position of the flow passage 27. The gas-liquid separating apparatus 13 is supplied with the circulation fuel from the fuel cell stack 5 through the flow passage 27. The gas-liquid separating apparatus 13 separates the gas (mainly carbon dioxide) and the liquid (mainly liquid fuel and water) contained in the circulation fuel. The gas is discharged outside (the atmosphere) through a gas-liquid separating membrane. The liquid is sent to the mixed fuel tank 2 through the flow passage 27. By closing the valves 22-1 and 22-2 when the gas-liquid separating apparatus 13 is not used, evaporation of the circulation fuel (liquid fuel) can be reduced. In addition, a pressure of the circulation fuel (liquid fuel) can be adjusted by adjusting an opening degree of the valve 22-2. As a result, the difference between the pressure of circulation fuel (liquid fuel) and the outside (atmosphere) pressure can be adjusted, making it possible to adjust efficiency of removing the gas. The details of the gas-liquid separating apparatus 13 will be mentioned later.

A liquid sensor 3 measures a liquid amount of the mixed fuel in the mixed fuel tank 2. A first temperature sensor 4 measures a temperature of the mixed fuel in the mixed fuel tank 2. A second temperature sensor 16 measures a temperature of air discharged from the oxidizer discharge outlet 29. A third temperature sensor 17 measures a temperature of the circulation fuel in the flow passage 27. A voltage probe 5a measures a voltage of a specific MEA in the fuel cell stack 5 and a voltage of a part where a given number of MEAs are stacked.

The microcomputer 9 controls an operation of the fuel cell section 14 by the pumps 6, 7 and 8, the valves 22-1 and 22-2, the shutter 23, and the oxidizer supply mechanism 28 based on output of the liquid sensor 3, the first temperature sensor 4 or the second temperature sensor 16, and the voltage probe 5a.

Next, the gas-liquid separating apparatus of the present invention will be described in detail.

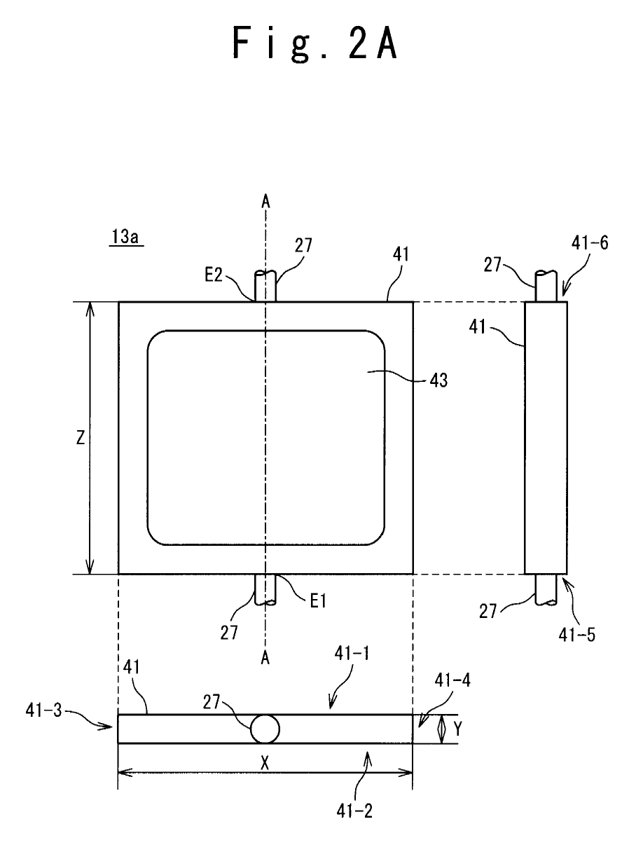

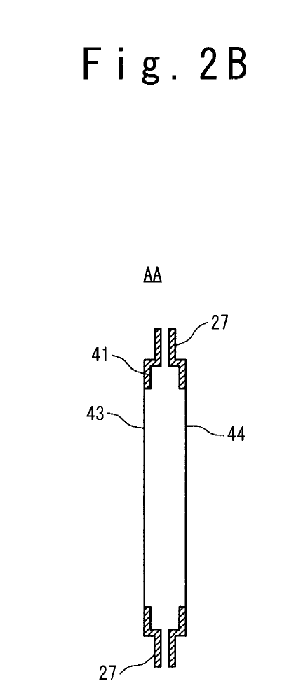

FIGS. 2A and 2B are diagrams showing the configuration of the gas-liquid separating apparatus according to the first exemplary embodiment of the present invention. FIG. 2A shows a 3-view diagram of the gas-liquid separating apparatus 13a, and FIG. 2B shows an AA section in FIG. 2A. The gas-liquid separating apparatus 13a includes a container 41, a gas-liquid separating membrane 43, and a gas-liquid separating membrane 44.

The container 41 has an approximate rectangular parallelopiped shape with a width X, a thickness Y, and a length Z. Thus, the container 41 has a first side surface 41-1, a second side surface 41-2, a third side surface 41-3, a fourth side surface 41-4, a fifth side surface 41-5, and a sixth side surface 41-6. The fifth side surface 41-5 and the sixth side surface 41-6 opposing to the fifth side surface 41-5 are provided approximately perpendicularly to the flow of circulation fuel in the flow passage 27. An inlet E1 and an outlet E2 for the circulation fuel are provided. The inlet E1 and the outlet E2 are connected to the flow passage 27. The first side surface 41-1 and the second side surface 41-2 opposing to the first side surface 41-1 have an area larger than the areas of the other side surfaces of the container 41. The gas-liquid separating membrane 43 and the gas-liquid separating membrane 44 are provided on the first side surface 41-1 and the second side surface 41-2, respectively. The third side surface 41-3 and the fourth side surface 41-4 opposing to the third side surface 41-3 are smaller (narrower) than the first side surface 41-1 and the second side surface 41-2. Concerning the fifth side surface 41-5 and the sixth side surface 41-6 of the container 41, it is preferable that the width X of the first side surface 41-1 and the second side surface 41-2 is longer than the thickness Y. The details thereof will be mentioned later.

The gas-liquid separating membrane 43 and the gas-liquid separating membrane 44 opposing to the gas-liquid separating membrane 43 are provided to the first side surface 41-1 and the second side surface 41-2, respectively. The gas contained in the circulation fuel introduced into the container 41 permeates outside the container 41 through the gas-liquid separating membranes 43 and 44. Therefore, it is preferable that the gas-liquid separating membranes are provided for the first side surface 41-1, the second side surface 41-2, the third side surface 41-3, and the fourth side surface 41-4. However, when this is difficult in terms of design, it is preferable that the gas-liquid separating membranes are provided for side surfaces with an area as large as possible and for at least two side surfaces opposing to each other, considering an attitude of the gas-liquid separating apparatus 13a. In this case, the first side surface 41-1 and the second side surface 41-2 are chosen. In addition, it is preferable for the gas-liquid separating membranes to cover areas as wider as possible of the first side surface 41-1 and the second side surface 41-2. This is because the gas can be discharged.

The gas-liquid separating membrane 43 (and 44) has a hydrophobic property (a liquid contact angle is close to 180 degrees) on the contact side with the liquid (liquid fuel), and has a great number of fine pores of approximately 0.1 to 1 μm. For this reason, the gas-liquid separating membrane 43 can effectively discharge the gas from the gas-liquid mixed fluid only when the gas is in contact with the membrane. An actual discharge amount depends on the number of fine pores and the area of fine pores in the gas-liquid separating membrane 43 (and 44) and a fluid pressure.

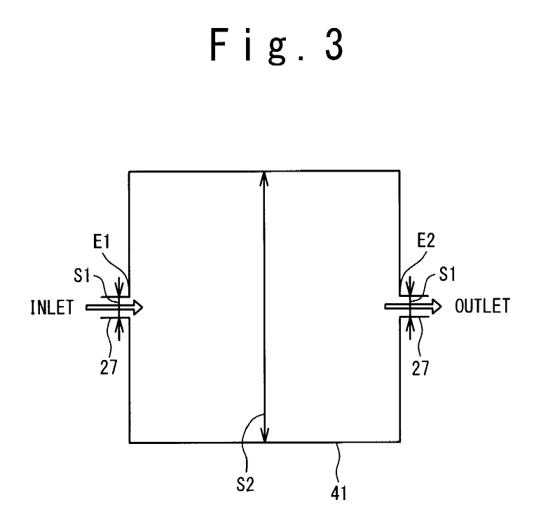

FIG. 3 is a schematic diagram showing the inside of the gas-liquid separating apparatus. A sectional area S1 of the flow passage 27 (the inlet E1) is smaller than a sectional area S2 of the container 41. Because of such a configuration, a flow speed of the circulation fuel is slower in the container 41 than in the flow passage 27. As a result, a time during which the circulation fuel stays in the container 41 becomes longer and bubbles of gas grow to increase their diameters. Consequently, a probability that the gas contacts with the gas-liquid separating membranes 43 and 44 is increased. That is, it is possible to more surely discharge the gas from the container 41.

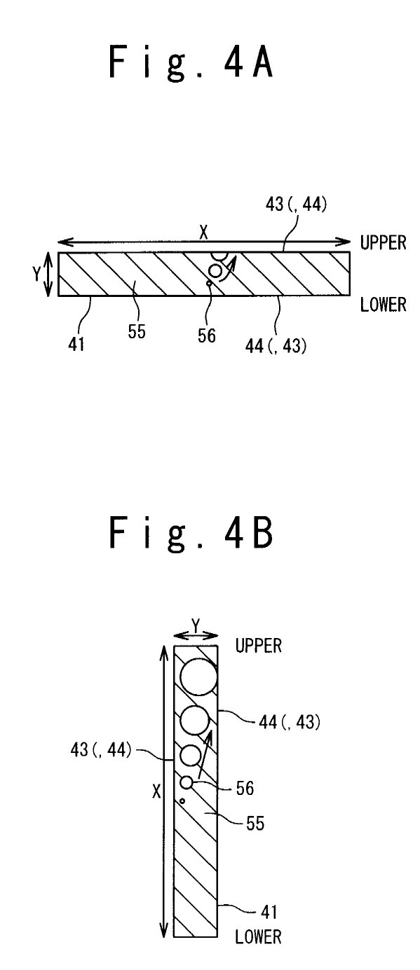

FIGS. 4A and 4B are conceptual diagrams showing movement of gas in the gas-liquid separating apparatus. FIG. 4A is a diagram when the container 41 is seen from the inlet E1. When the gas-liquid separating apparatus 13a takes a attitude as shown in FIG. 4A, the gas in the form of bubbles 56 goes upward in a direction of the thickness (Y) due to difference in specific gravity from the circulation fuel 55. The gas in the form of bubbles 56 then reaches the gas-liquid separating membrane 43 (44), which is provided upward, to be discharged therefrom.

On the other hand, when the gas-liquid separating apparatus 13a takes an attitude as shown in FIG. 4B, the gas 56 goes upward in a direction of the width (X) due to difference in specific gravity from the circulation fuel 55. At this time, there is a fear that the gas 56 is not discharged from the gas-liquid separating apparatus 13a, since the gas-liquid separating membrane is not provided for the side surface 41-4 (41-3). However, a bubble 56 combines with surrounding bubbles 56 to grow larger with its movement as time passes, resulting in increase in its diameter. A probability of the bubble contacting with the gas-liquid separating membrane 43 (44) increases as the diameter is increased. In this case, the bubble 56 can easily come into contact with the gas-liquid separating membrane 43 (44) as the thickness Y is smaller, even when the diameter of the bubble 56 is small. Additionally, a time required for the bubble 56 to grow can be ensured, since a flow speed of the circulation fuel is lowered as the width X is increased. Therefore, the diameter of the bubble is increased and the bubble easily comes in contact with even the gas-liquid separating membranes 43 (44). That is, a probability that the bubble 56 comes into contact with the gas-liquid separating membrane 43 (44) increases as the thickness Y is smaller and the width X is larger (Y<X), making it possible to more surely discharge the gas 56 from the gas-liquid separating membrane 43 (44). A specific thickness Y is preferably 1 mm or above to prevent rapid increase of fluid resistance. As for the width X, it is required that the thickness Y is equal to or smaller than the width X (Y≦X), in order to decrease the flow speed of the circulation fuel 55 and to increase a probability that the gas comes into contact with the gas-liquid separating membrane, when an external diameter of the inlet E1 is equal to Y. However, it should be noted that 5Y≦X is preferable and 10Y≦X is more preferable, since it is required to easily assemble gas-liquid separating membranes. An upper limit is determined from the point of view of design.

Since fuel consumption of a DMFC is: methanol 0.25 g/MEA/h/A; and water 0.11 g/MEA/h/A under an ideal condition, at least 0.36 g/h of fuel needs to be supplied to generate electric power of 1 A per 1 MEA. However, since the MEA has a limited area in reality and fuel of a given concentration or above needs to be supplied uniformly to the whole area, it is preferable that fuel circulation that entire fuel is approximately re-supplied is performed. This is also effective in cooling a fuel cell. Since a capacity of the container 41 required to generate the electric power of 1 A per 1 MEA is considered to be approximately 10 cm² to 20 cm²×1 mm, a flow rate required for the fuel circulation is 1 to 2 cc/min. Additionally, since CO₂ (gas) simultaneously generated is approximately 2 cc/min, a ratio of fluid fuel actually flowing through the flow passage 27 to CO₂ gas is approximately equal to 1:1. To circulate the liquid fuel (the mixed fuel and the circulation fuel), pressure is applied to the liquid fuel by the pump 8.

However, the pressure is approximately 100 kPa (approximately equal to atmospheric pressure) at the maximum when considering application to the small electronic apparatus, and it is possible to consider that CO₂ volume is diminished approximately by a half.

In case of separating CO₂ from the circulation fuel by the gas-liquid separating apparatus 13a when a pipe diameter of the flow passage 27 is approximately 2 to 3 mmØ or below, the section is certainly filled up with CO₂. Since the circulation fuel flow rate is 4 cc/min at most, the flow speed inside the pipe is approximately 10 mm/s. Here, when the gas-liquid separating membranes 43 (44) are provided on the top and bottom surfaces of the gas-liquid separating apparatus 13a and the thickness thereof has approximately the same thickness as the pipe diameter of the flow passage 27, CO₂ practically comes into contact with the top and bottom surfaces of the gas-liquid separating apparatus 13a. Furthermore, since the flow speed drops to approximately 1 mm/s when the sectional area S2 of the gas-liquid separating apparatus 13a is about ten times the sectional area of the flow passage 27, the diameters of the gas bubbles of CO₂ in the circulation fuel can be enlarged. Consequently, it is possible to certainly make the gas bubbles of CO₂ contact with the gas-liquid separating membrane 43 (44). For this reason, CO₂ can certainly be discharged when the length Z has a value of approximately 5 mm to 10 mm, considering a time during which the gas bubbles permeate or transmit the gas-liquid separating membrane 43 (44), although depending on the performance of the gas-liquid separating membrane 43 (44).

Therefore, dimensions of the gas-liquid separating apparatus 13a preferably have values mentioned below, considering the above argument. First, the thickness Y is approximately a same extent as an inflow pipe diameter or below and is preferably 1 mm or above to 5 mm or below. The width X is preferably about five times and more preferably about ten times the thickness Y or above. The length Z is preferably 5 mm or above and is more preferably 10 mm or above. An upper limit is determined from the point of view of design. 5 mm or below is insufficient for gas bubbles to transmit the gas-liquid separating membrane 43 (44). Additionally, it is possible to respond to a case where the number of MEAs and electric current are increased, by mainly increasing the length Z. The gas-liquid separating membrane 43 (44) just needs to cover a region slightly smaller than the area of X times Z on the top and bottom surfaces. By setting such values, installation in the small electronic apparatus become easily possible.

By using such a gas-liquid separating apparatus, the gas can come into contact with the gas-liquid separating membrane without depending on attitude of the small electronic apparatus. Therefore, it is possible to separate the liquid fuel and the gas without depending on the attitude and make small electronic apparatus stably operate.

Next, an operation of a polymer electrolyte fuel cell according to an exemplary embodiment of the present invention will be described.

The microcomputer 9 controls at least one of the pumps 6 and 7 to operate while referring to the liquid sensor 3 and the first temperature sensor 4. As a result, at least one of the high concentration of fuel and the low-concentrated fuel is supplied to the mixed fuel tank 2. On the other hand, the circulation fuel is supplied from the fuel cell stack 5 to the mixed fuel tank 2 through the flow passage 27. The high concentration of fuel, the low-concentrated fuel, and the circulation fuel are mixed into the mixed fuel in the mixed fuel tank 2. The microcomputer 9 controls the pump 8 to operate while referring to the voltage probe 5a. Consequently, the mixed fuel is supplied to the fuel cell stack 5. The microcomputer 9 allows the oxidizer supply fan 28 to operate by opening the shutter 23. Consequently, air is supplied to the fuel cell stack 5. The fuel cell stack 5 generates electric power using the mixed fuel and the air. Due to the generation of electric power, carbon dioxide (gas) is generated on the side of a fuel electrode. The fuel cell stack 5 supplies the circulation fuel to the gas-liquid separating apparatus 13a through the flow passage 27 as the remaining mixed fuel. The circulation fuel contains carbon dioxide (gas). A pressure when the circulation fuel flows from the inlet E1 of the gas-liquid separating apparatus 13a produces a difference in pressure between fluid in the container 41 and the atmosphere through the gas-liquid separating membranes 43 and 44, and the gas passes through the gas-liquid separating membranes 43 and 44. Consequently, the gas-liquid separating apparatus 13a separates and removes the carbon dioxide (gas) from the supplied the circulation fuel. The gas-liquid separating apparatus 13a then sends the circulation fuel from which the carbon dioxide gas has been removed, to the mixed fuel tank 2.

Since the gas-liquid separating apparatus 13a has the above-mentioned configuration, it is possible at the time of the above operation to make the gas contact the gas-liquid separating membrane without depending on the attitude of the small electronic apparatus that is provided with a polymer electrolyte fuel cell having the gas-liquid separating apparatus 13a. Therefore, it is possible to separate the liquid fuel and the gas without depending on the attitude and make the small electronic apparatus stably operate.

### Second Exemplary Embodiment

The configurations of the gas-liquid separating apparatus and the polymer electrolyte fuel cell according to the second exemplary embodiment of the present invention will be described. The configuration of the gas-liquid separating apparatus 13b in the second exemplary embodiment is different from that of the gas-liquid separating apparatus 13a in the first exemplary embodiment.

FIG. 1 is a block diagram showing the configuration of the polymer electrolyte fuel cell according to the second exemplary embodiment of the present invention. The configuration of the polymer electrolyte fuel cell is the same as in the first exemplary embodiment and description thereof will be omitted.

Next, the gas-liquid separating apparatus of the present invention will be described in detail.

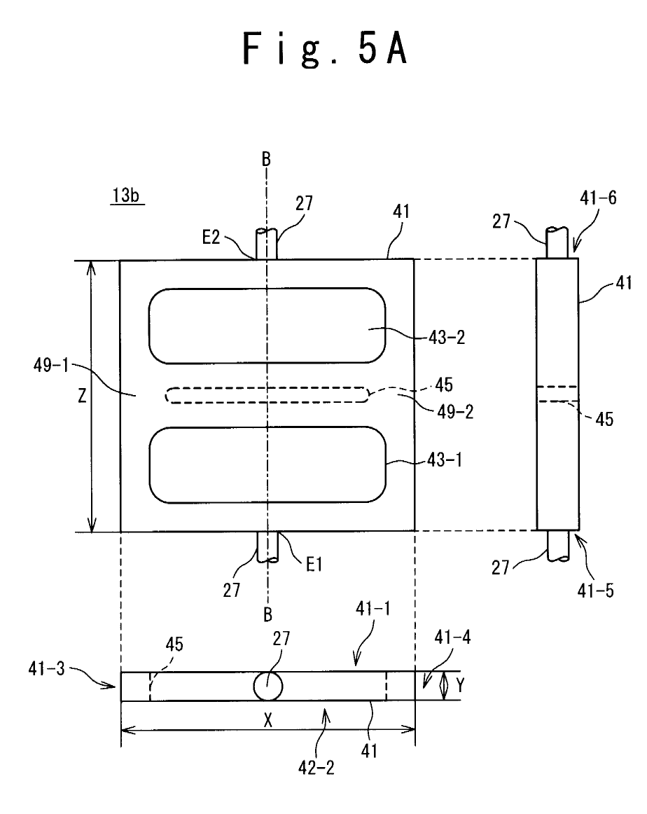

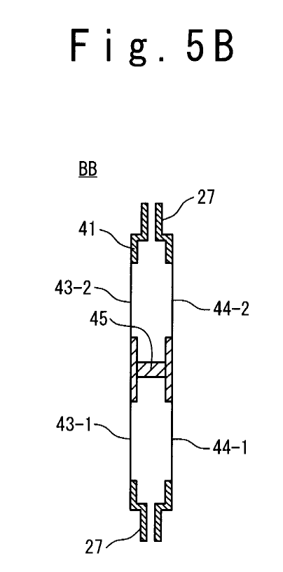

FIGS. 5A and 5B are diagrams showing the configuration of the gas-liquid separating apparatus 13b according to the second exemplary embodiment of the present invention. FIG. 5A shows a 3-view diagram of the gas-liquid separating apparatus 13b and FIG. 5B shows a BB section in FIG. 5A. The gas-liquid separating apparatus 13b has a container 41, gas-liquid separating membranes 43-1 and 43-2, gas-liquid separating membranes 44-1 and 44-2, and a partition member 45.

The container 41 has an approximate rectangular parallelopiped shape with the width X, the thickness Y, and the length Z. The container 41 has the first side surface 41-1, the second side surface 41-2, the third side surface 41-3, the fourth side surface 41-4, the fifth side surface 41-5, and the sixth side surface 41-6. The fifth side surface 41-5 and the sixth side surface 41-6 opposing to the fifth side surface 41-5 are provided approximately perpendicularly to the flow of the circulation fuel through the flow passage 27, which respectively have an inlet E1 and an outlet E2 for the circulation fuel. The inlet E1 and the outlet E2 are connected to the flow passage 27. The first side surface 41-1 and the second side surface 41-2 opposing to the first side surface 41-1 have an area larger than the areas of the other side surfaces of the container 41. The gas-liquid separating membranes 43-1 and 43-2 and the gas-liquid separating membranes 44-1 and 44-2 are provided for the first side surface 41-1 and the second side surface 41-2, respectively. The third side surface 41-3 and the fourth side surface 41-4 opposing to the third side surface 41-3 are smaller (narrower) than the first side surface 41-1 and the second side surface 41-2. Concerning the fifth side surface 41-5 and the sixth side surface 41-6 of the container 41, it is preferable that the width X in the first side surface 41-1 and the second side surface 41-2 is longer than the thickness Y. The reason is as mentioned in the first exemplary embodiment.

A partition member 45 is provided inside the container 41 to change the flow direction of the circulation fuel introduced from the inlet E1. In more detail, the partition member 45 is provided in a central region of the container 41 in the length (Z) direction to extend in the width (X) direction excluding both ends. The partition member 45 extends in the entire thickness (Y) direction to the side surfaces 41-1 and 41-2. Flow passages 49-1 and 49-2 for the circulation fuel are formed in the both ends in the width direction. The circulation fuel is introduced from the inlet E1 toward the partition member 45, whose flow is changed by the partition member 45, and is sent to the outlet E2 through the flow passage 49-1 or the flow passage 49-2 on the both sides.

The gas-liquid separating membranes 43-1 and 43-2 and the gas-liquid separating membranes 44-1 and 44-2 opposing to the gas-liquid separating membranes 43-1 and 43-2 are provided to the first side surface 41-1 and the second side surface 41-2, respectively. In more detail, the gas-liquid separating membrane 43-1 and the gas-liquid separating membrane 44-1 are provided for the first side surface 41-1 and the second side surface 41-2 from the vicinity of the inlet E1 to the vicinity of the partition member 45, respectively. The gas-liquid separating membrane 43-2 and the gas-liquid separating membrane 44-2 are provided for the first side surface 41-1 and the second side surface 41-2 from the vicinity of the partition member 45 to the vicinity of the outlet E2, respectively. The gas contained in the circulation fuel introduced into the container 41 transmits to the outside of the container 41 through the gas-liquid separating membrane 43 (43-1 and 43-2) and the gas-liquid separating membrane 44 (44-1 and 44-2). It is preferable that the gas-liquid separating membrane 43 and the gas-liquid separating membrane 44 are provided for a side surface with an area as large as possible and are provided to two side surfaces opposing to each other at least, taking into account the attitude of the gas-liquid separating apparatus 13b. In this case, the first side surface 41-1 and the second side surface 41-2 are applicable. It is preferable that the areas as large as possible of the first side surface 41-1 and the second side surface 41-2 are covered. This is because the gas can be discharged.

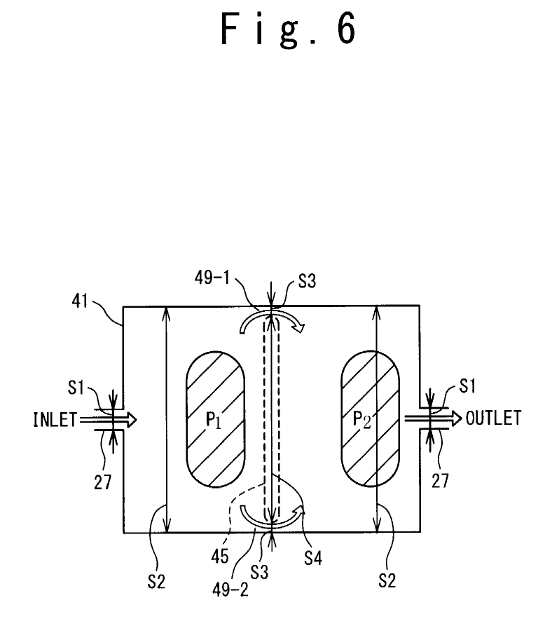

FIG. 6 is a schematic diagram showing the inside of the gas-liquid separating apparatus. A sectional area S1 of the flow passage 27 (inlet E1) is smaller than a sectional area S2 of the container 41. The partition member 45 with the sectional area S4 is provided in a position within the container 41, where the flow of the circulation fuel is changed. A sectional area S3 of the flow passage 49-1 or 49-2 formed by the partition member 45 is smaller than the sectional area S2. By such a configuration, flow speed of the circulation fuel is slower in the container 41 than in the flow passage 27 and the circulation fuel is likely to stay in a region P1 before the partition member 45. As a result, a time during which the circulation fuel stays in the container 41 becomes longer and bubbles of the gas grow to increase their diameters.

Since the gas-liquid separating membranes 43-1 and 44-1 are provided to the first side surface 41-1 and the second side surface 41-2 corresponding to the region PI, a probability that the gas comes into contact with the gas-liquid separating membrane is more increased. Consequently, it is possible to more definitely discharge gas from the container 41.

The same is applied to a region P2 before the sixth side surface 41-6. In this case, the flow speed of the circulation fuel is slower in the region P2 (the sectional area S2) than in the flow passages 49-1 and 49-2 (the sectional area S3) and the circulation fuel is likely to stay in the region P2. As a result, a time during which the circulation fuel stays in the container 41 becomes longer and bubbles of the gas grow to increase their diameters. Since the gas-liquid separating membranes 43-2 and 44-2 are provided to the first side surface 41-1 and the second side surface 41-2 corresponding to the region P2, the probability that the gas comes into contact with the gas-liquid separating membranes is more increased. Consequently, it is possible to more definitely discharge gas from the container 41.

In addition, it is preferable to provide narrow flow passages like the flow passages 49-1 and 49-2 in the container 41, which makes it possible to combine the bubbles of gas to increase their diameters. As a result, the gas that has not separated in gas-liquid separation in the region P1 in gas-liquid separation can be easily separated in the region P2, and the gas can more surely be discharged from the container 41.

In a flow passage for the circulation fuel as mentioned above, it is preferable that a narrow region where flow speed is high (e.g., the flow passage 27 and the flow passages 49-1 and 49-2) and a wide area where flow speed is low (e.g., the regions P1 and P2) be alternately arranged, which makes it possible to accelerate growth of the gas bubbles in a region where the flow speed is low, and to efficiently perform removal of the gas bubbles from the small electronics apparatus in a short period of time by further providing the gas-liquid separating membrane in this region.

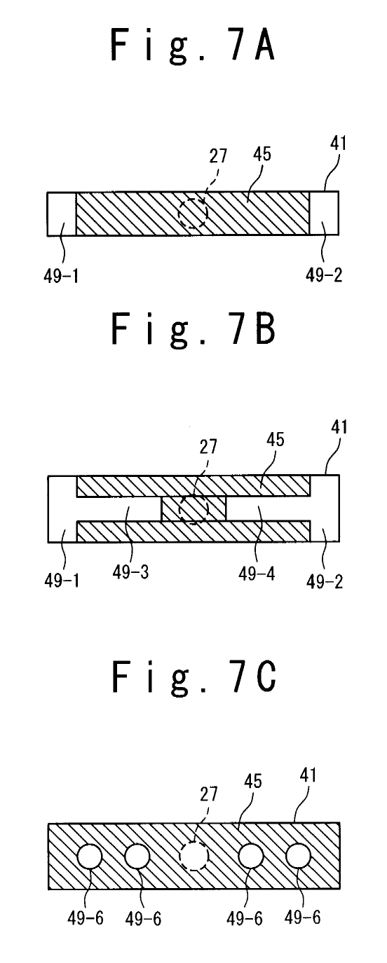

FIGS. 7A to 7C are schematic diagrams showing shapes of the partition member 45. They are the diagrams seen from the side of the inlet E1. FIG. 7A corresponds to a case of the partition member 45 in FIGS. 5A and 5B. That is, the partition member 45 is provided in a region excluding the both ends of the width (X) direction (the right and left directions in the diagram) along the entire thickness (Y) direction (the upper and lower directions in the diagram). The both ends of the width direction constitute the flow passages 49-1 and 49-2. The circulation fuel from the inlet E1 flows toward a projection position of the flow passage 27 shown by a dotted line in the diagram. However, the flow is changed by the partition member 45 to go into the flow passages 49-1 and 49-2.

The shapes of the partition member 45 are not limited to the above example, and it is sufficient that the flow direction of the circulation fuel from the inlet E1 is changed. For instance, examples as mentioned below will be considered.

The partition member 45 shown in FIG. 7B is provided in the thickness (Y) direction in the central portion in the width (X) direction. The partition member 45 is provided in a region other than the central region in the thickness (Y) direction in a portion excluding the central portion and the both ends in the width (X) direction. The partition member 45 is not provided in the both ends in the width (X) direction. The both ends in the width direction provide the flow passages 49-1 and 49-2. The region for the central portion in the width direction where there is no the partition member is for flow passages 49-3 and 49-4. In this case, the circulation fuel from the inlet E1 flows toward a projection position of the flow passage 27 shown by a dotted line in the diagram. However, the flow is changed by the partition member 45 to go into the flow passages 49-1, 49-2, 49-3, and 49-4.

The partition member 45 shown in FIG. 7C is provided in the entire width (X) direction along the entire thickness (Y) direction. However, a plurality of holes of flow passages 49-6 are provided in the central portion in the thickness (Y) direction in a region excluding the vicinity of the central portion of the width (X) direction. In this case, the circulation fuel from the inlet E1 flows toward a projection position of the flow passage 27 shown by a dotted line in the diagram. However, the flow is changed by the partition member 45 to go into the plurality of flow passages 49-6.

It should be noted that the partition member 45 is provided here. However, it is also possible to practically form the gas-liquid separating apparatus 13b by connecting two gas-liquid separating apparatuses 13a in the first exemplary embodiment with one or two fine tubes of approximately the sectional areas S1 to S3, for instance.

As for the movement of gas in the gas-liquid separating apparatus shown in FIGS. 4A and 4B, the same idea can be applied to the present exemplary embodiment. As a result, it is possible to make the gas contact with the gas-liquid separating membrane more certainly without depending on the attitude of the small electronic apparatus. Therefore, it is possible to separate the liquid fuel and the gas more certainly without depending on the attitude and make the small electronic apparatus stably operate.

An operation of the polymer electrolyte fuel cell according to the second exemplary embodiment of the present invention is the same as that of the first exemplary embodiment except for the use of the gas-liquid separating apparatus 13b, and the description thereof will be omitted.

By using such a gas-liquid separating apparatus, it is possible to make the gas contact with the gas-liquid separating membrane more effectively without depending on the attitude of the small electronic apparatus. Therefore, it is possible to more effectively separate the liquid fuel and the gas without depending on the attitude and make the small electronic apparatus stably operate.

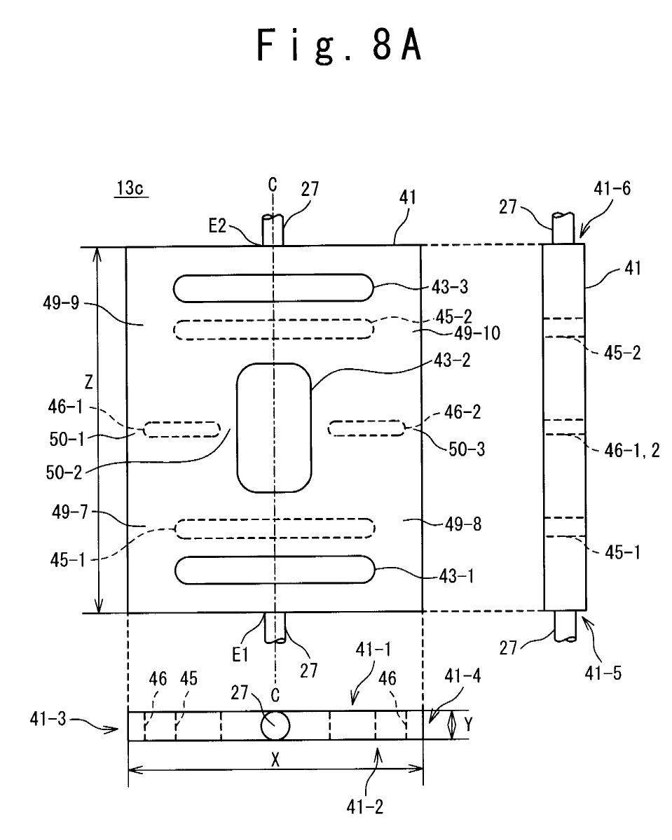

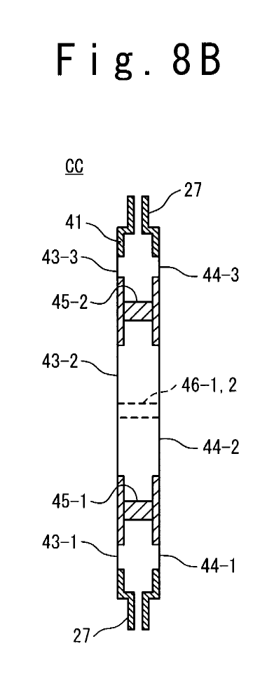

The gas in the container 41 permeates or transmits the gas-liquid separating membranes 43 and 44 because of a pressure difference between the fluid in the container 41 and the atmosphere. For this reason, the pressure difference can be increased to improve gas permeability by increasing partition members in the container 41 to intentionally increase the pressure of fluid in the container 41. As a result, the gas permeability can be increased. At this time, it is preferable that the gas-liquid separating membrane is provided in a position where fluid is likely to stay (e.g., upstream side of the partition member), in correspondence to the increase of partition members. The examples are shown in FIGS. 8A and 8B.

FIGS. 8A and 8B are diagrams showing the configuration of the gas-liquid separating apparatus according to a modification example of the second exemplary embodiment of the present invention. FIG. 8A shows a 3-view diagram of the gas-liquid separating apparatus 13c, and FIG. 8B shows a CC section in FIG. 8A. The gas-liquid separating apparatus 13c has the container 41, gas-liquid separating membranes 43-1, 43-2, and 43-3, gas-liquid separating membranes 44-1, 44-2, and 44-3, and partition members 45-1, 45-2, 46-1, and 46-2.

The container 41 has an approximate rectangular parallelopiped shape having the width X, the thickness Y, and the length Z. The container 41 has the first side surface 41-1, the second side surface 41-2, the third side surface 41-3, the fourth side surface 41-4, the fifth side surface 41-5, and the sixth side surface 41-6. The fifth side surface 41-5 and the sixth side surface 41-6 opposing to the fifth side surface 41-5 are provided approximately perpendicular to the flow of the circulation fuel in the flow passage 27. The container 41 has an inlet E1 and an outlet E2 for the circulation fuel. The inlet E1 and the outlet E2 are connected to the flow passage 27. The first side surface 41-1 and the second side surface 41-2 opposing to the first side surface 41-1 have an area larger than the areas of the other side surfaces of the container 41. The gas-liquid separating membranes 43-1, 43-2, and 43-3 and the gas-liquid separating membranes 44-1, 44-2, and 44-3 are provided for the first side surface 41-1 and the second side surface 41-2, respectively. The third side surface 41-3 and the fourth side surface 41-4 opposing to the third side surface 41-3 are smaller (narrower) than the first side surface 41-1 and the second side surface 41-2. Concerning the fifth side surface 41-5 and the sixth side surface 41-6 of the container 41, it is preferable that the width X of the first side surface 41-1 or the second side surface 41-2 is longer than the thickness Y. The reason is as mentioned in the first exemplary embodiment.

The partition member 45-1 is provided inside the container 41 to change the flow direction of the circulation fuel introduced from the inlet E1. In more detail, the partition member 45-1 is provided in a region excluding the both ends in the width (X) direction along the entire thickness (Y) direction, positioned on the side of the inlet E1 from the center portion of the container 41 in the length (Z) direction. The both ends of the width direction forms flow passages 49-7 and 49-8 of the circulation fuel. The circulation fuel is introduced from the inlet E1 toward the partition member 45-1. However, the flow direction is changed by the partition member 45-1 to pass through the flow passage 49-7 or the flow passage 49-8.

The gas-liquid separating membrane 43-1 and the gas-liquid separating membrane 44-1 opposing to the gas-liquid separating membrane 43-1 are provided to the first side surface 41-1 and the second side surface 41-2, respectively. In more detail, the gas-liquid separating membrane 43-1 and the gas-liquid separating membrane 44-1 are provided for the first side surface 41-1 and the second side surface 41-2 in regions from the vicinity of the inlet E1 to the vicinity of the partition member 45-1, respectively. The gas contained in the circulation fuel introduced into the container 41 permeates or transmits to the outside of the container 41 through the gas-liquid separating membranes 43-1 and 44-1. It is preferable that the gas-liquid separating membranes 43-1 and 44-1 cover as large areas as possible. This is because the gas can be fully discharged.

The partition members 46-1 and 46-2 are provided inside the container 41 to change the flow direction of the circulation fuel that has passed through the flow passage 49-7 or the flow passage 49-8. In more detail, the partition members 46-1 and 46-2 are provided in the central portion of the container 41 in the length (Z) direction excluding the both ends and the central potion in the width (X) direction, along the entire thickness (Y) direction. The both ends and the central portion in the width direction are flow passages 50-1, 50-3, and 50-2 for the circulation fuel. The circulation fuel is introduced from the flow passage 49-7 or the flow passage 49-8 toward the partition members 46-1 and 46-2. However, the flow direction is changed by the partition members 46-1 and 46-2 to pass through any one of the flow passages 50-1, 50-3, and 50-2.

The gas-liquid separating membrane 43-2 and the gas-liquid separating membrane 44-2 opposing to the gas-liquid separating membrane 43-2 are provided to the first side surface 41-1 and the second side surface 41-2, respectively. In more detail, the gas-liquid separating membrane 43-2 and the gas-liquid separating membrane 44-2 are provided to the first side surface 41-1 and the second side surface 41-2 in a position that does not involve the partition members 46-1 and 46-2 in a region from the partition member 45-1 to the partition member 45-2. The gas contained in the circulation fuel introduced into the container 41 permeates or transmits to the outside of the container 41 through the gas-liquid separating membranes 43-2 and 44-2. It is preferable that the gas-liquid separating membranes 43-2 and 44-2 cover as large areas as possible. This is because gas can be discharged.

The partition member 45-2 is provided inside the container 41 to change the flow direction of the circulation fuel that has passed through the flow passages 50-1, 50-3, and 50-2. In more detail, the partition member 45-2 is provided in a region excluding the both ends in the width (X) direction along the thickness (Y) direction, positioned on the side of the outlet E2 from the central portion of the container 41 in the length (Z) direction. The both ends in the width direction are flow passages 49-9 and 49-10 for the circulation fuel. The circulation fuel is introduced from the flow passages 50-1, 50-3, and 50-2 toward the partition member 45-2. However, the flow direction is changed by the partition member 45-2 to pass through the flow passage 49-9 or the flow passage 49-10.

The gas-liquid separating membrane 43-3 and the gas-liquid separating membrane 44-3 opposing to the gas-liquid separating membrane 43-3 are provided to the first side surface 41-1 and the second side surface 41-2. In more detail, the gas-liquid separating membrane 43-3 and the gas-liquid separating membrane 44-3 are provided for the first side surface 41-1 and the second side surface 41-2 in a region from the partition member 45-2 to the outlet E2, respectively. The gas contained in the circulation fuel introduced into the container 41 permeates or transmits to the outside of the container 41 through the gas-liquid separating membranes 43-3 and 44-4. It is preferable that the gas-liquid separating membranes 43-3 and 44-3 cover as large areas as possible. This is because the gas can be fully discharged.

Even in the above gas-liquid separating apparatus 13c, the same effect as the gas-liquid separating apparatus 13b in FIGS. 5A and 5B can be accomplished. In addition, the small electronic apparatus equipped with the gas-liquid separating apparatus 13c can accomplish the same effect as a small electronic apparatus equipped with the gas-liquid separating apparatus 13b.

Additionally, it is possible to raise the pressure of fluid in the container 41 and increase pressure difference to improve gas permeability, also by making the outlet E2 narrower than the inlet E1. As a result, the gas permeability can be increased.

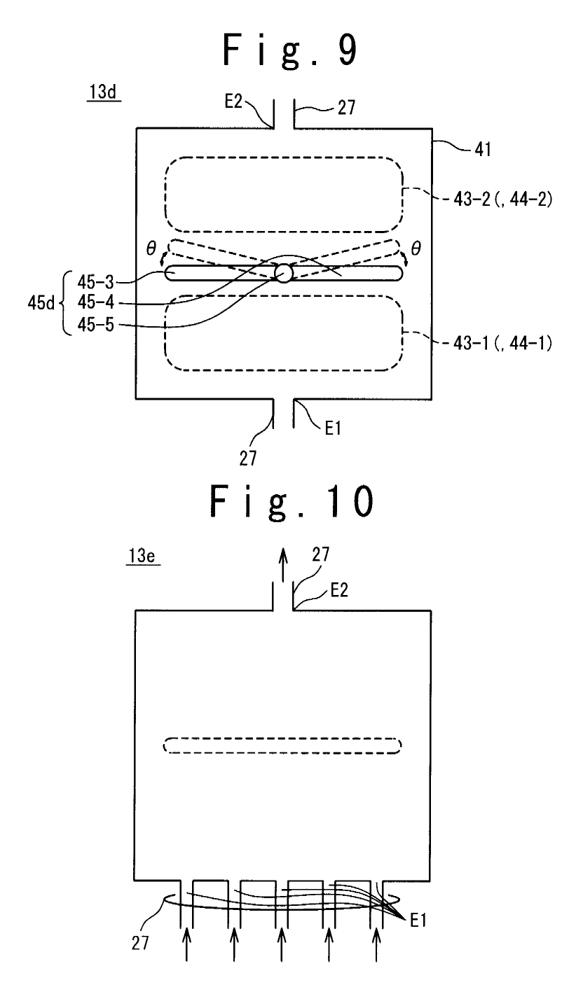

FIG. 9 is a diagram showing the configuration of the gas-liquid separating apparatus according to another modification example of the second exemplary embodiment of the present invention.

A gas-liquid separating apparatus 13d is basically the same as the gas-liquid separating apparatus 13b in FIGS. 5A and 5B. However, a partition member 45d is different from the partition member 45 of the gas-liquid separating apparatus 13b in that the partition member 45d is movable. The partition member 45d is the same as the partition member 45 in terms of the shape seen from the side of the inlet E1. A movable partition member 45-3, a movable partition member 45-4, and a movable mechanism 45-5 are provided.

The respective ends of the movable partition members 45-3 and 45-4 are connected turnably to the movable mechanism 45-5. The turning is possible in a direction parallel to the first side surface 41-1 (the second side surface 41-2) in the container 41 with the movable mechanism 45-5 as the center by a given angle θ. The movable mechanism 45-5 is fixedly provided to a center portion of the container 41. The movable mechanism 45-5 is connected to the respective ends of the movable partition members 45-3 and 45-4, serving as the center of the rotation thereof. The movable mechanism 45-5 is exemplified by a configuration having a torsion spring, with two arms thereof being respectively connected with the movable partition members 45-3 and 45-42, for example. By employing such a movable mechanism with a tensioner using a suitable torsion spring, resistance to the circulation fuel can be uniform.

FIG. 10 is a diagram showing the configuration of the gas-liquid separating apparatus according to another modification example of the second exemplary embodiment of the present invention. A gas-liquid separating apparatus 13e is basically the same as the gas-liquid separating apparatus 13b in FIGS. 5A and 5B. However, there is difference from the gas-liquid separating apparatus 13b in that the gas-liquid separating apparatus 13e has a plurality of inlets E1 and a single outlet E2. In this case, by providing the flow passage 27 and the inlet E1 to each of a plurality of MEAs, for example, uniform fuel supply is possible to each of the MEAs since back pressures of the circulation fuel of the MEAs at the outlet can approximately be equalized.

It should be noted that the technique applied to the above-mentioned gas-liquid separating apparatuses 13 (13a, 13b, 13c, 13d, and 13e) can mutually be used provided that there is no mutual contradiction.

According to the present invention, it is possible to obtain a gas-liquid separating apparatus that can separate gas generated by power generation and liquid fuel without depending on attitudes of the small electronic apparatus.

It would be obvious that the present invention is not limited to the above-mentioned exemplary embodiments and each of the exemplary embodiments can properly be modified or changed within the scope of the technical features of the present invention.

1. A gas-liquid separating apparatus for a fuel cell, comprising:
a container having a substantially rectangular parallelopiped shape and having an inlet and an outlet for liquid; and
first gas-liquid separating membranes provided for two first side surfaces opposing to each other in said container, respectively,
wherein a first side line between one of said first side surfaces and one of second side surfaces on which said inlet and said outlet are provided in said container is longer than a second side line between said second side surface and one of third side surfaces orthogonal to said first and second side surfaces in said container.

2. The gas-liquid separating apparatus according to claim 1, wherein areas of said two first side surfaces opposing to each other are larger than an area of any of the other side surfaces of said container.

3. The gas-liquid separating apparatus according to claim 1, wherein a length X of the first side line and a length Y of the second side line satisfy a relation of 5Y≦X.

4. The gas-liquid separating apparatus according to claim 1, wherein said container comprises a first partition member provided in said container to change a direction of a flow of the liquid, and
said first gas-liquid separating membranes are provided for said two first side surfaces opposing to each other in a region from said inlet to said first partition member.

5. The gas-liquid separating apparatus according to claim 4, further comprising:
second gas-liquid separating membranes provided for said two first side surfaces opposing to each other in a region from said first partition member to said outlet.

6. The gas-liquid separating apparatus according to claim 4, wherein said first partition member is provided in a direction of the liquid flow from the inlet to change the liquid flow, and
said container has flow passages which are provided inside or around said first partition member and through which the liquid whose flow direction is changed flows.

7. The gas-liquid separating apparatus according to claim 4, wherein said first partition member is provided to be movable in response to a force of the liquid flow.

8. The gas-liquid separating apparatus according to claim 4, wherein said container has a first portion having a larger sectional area than a sectional area of said inlet and a second portion having a smaller sectional area than said first portion, and
said first gas-liquid separating membranes are provided for two first side surfaces opposing to each other in said first portion.

9. A gas-liquid separating apparatus for a fuel cell, comprising:
a container having an inlet and an outlet for liquid; and
first gas-liquid separating membranes provided for two first side surfaces of said container opposing to each other,
wherein said container comprises a first partition member provide to change a direction of a flow of the liquid, and
said first gas-liquid separating membranes are provided to said two first side surfaces opposing to each other in a region from said first partition member to said inlet.

10. The gas-liquid separating apparatus according to claim 9, wherein said gas-liquid separating membranes are provided two first side surfaces opposing to each other in a region from said first partition member to said outlet.

11. The gas-liquid separating apparatus according to claim 9, wherein said first partition member is provided in to change a direction of a liquid flow, and
said container has flow passages which are provided inside or around said first partition member and through which the liquid whose flow direction is changed flows.

12. The gas-liquid separating apparatus according to claim 9, wherein said partition member is provided to be movable in response to a force of the liquid flow.

13. A liquid supply type fuel cell comprising:
a fuel cell main body;
a fuel supply section configured to reserve liquid fuel;
a mixed fuel supply section configured to reserve mixed fuel obtained by mixing said liquid fuel and circulation fuel discharged from said fuel cell main body, and to supply the mixed fuel to said fuel cell main body; and
a gas-liquid separating apparatus provided between said fuel cell main body and said mixed fuel supply section to remove a gas from said circulation fuel discharged from said fuel cell main body,
wherein said gas-liquid separating apparatus comprises:
a container having an inlet and an outlet for liquid; and
first gas-liquid separating membranes provided for two first side surfaces of said container opposing to each other,
wherein said container comprises a first partition member provide to change a direction of a flow of the liquid, and
said first gas-liquid separating membranes are provided to said two first side surfaces opposing to each other in a region from said first partition member to said inlet.

14. The liquid supply type fuel cell according to claim 13, wherein said gas-liquid separating membranes are provided two first side surfaces opposing to each other in a region from said first partition member to said outlet.

15. The liquid supply type fuel cell according to claim 13, wherein said first partition member is provided in to change a direction of a liquid flow, and
said container has flow passages which are provided inside or around said first partition member and through which the liquid whose flow direction is changed flows.

16. The liquid supply type fuel cell according to claim 13, wherein said partition member is provided to be movable in response to a force of the liquid flow.

17. The liquid supply type fuel cell according to claim 13, wherein a first side line between one of said first side surfaces and one of second side surfaces on which said inlet and said outlet are provided in said container is longer than a second side line between said second side surface and one of third side surfaces orthogonal to said first and second side surfaces in said container.

18. The liquid supply type fuel cell according to claim 13, wherein areas of said two first side surfaces opposing to each other are larger than an area of any of the other side surfaces of said container.

19. The liquid supply type fuel cell according to claim 13, wherein a length X of the first side line and a length Y of the second side line satisfy a relation of 5Y≦X.

20. The liquid supply type fuel cell according to claim 13, wherein said container has a first portion having a larger sectional area than a sectional area of said inlet and a second portion having a smaller sectional area than said first portion, and
said first gas-liquid separating membranes are provided for two first side surfaces opposing to each other in said first portion.
